(19) United States
(12) Patent Application Publication
(10) Pub. No.: US 2009/0103783 A1
(43) Pub. Date: Apr. 23, 2009

(54) System and Method for Biometric Behavior Context-Based Human Recognition

(75) Inventor: Artem L. Yukhin, Moscow (RU)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(73) Assignee: Artec Ventures, Moscow (RU)

(21) Appl. No.: 11/875,709

(22) Filed: Oct. 19, 2007

(51) Int. Cl. G06K 9/00

(52) U.S. Cl. 382/116

(57) ABSTRACT

A system and method are provided for the biometric recognition of a human being based on a combination of biological and behavioristic traits to achieve increased recognition accuracy and to protect against false identifications based on imitated traits. Behavioristic traits comprise biometric traits involving behavior acquired by a human being during his or her lifetime that are capable of being associated with an individual. A plurality of time-sequenced 5D images of a person's body can be captured of a person and used to recognize a person based on his/her behavioristic traits by comparing time variable components in the 5D images with stored values associated with the behavioristic traits of respective persons, while the person can be further recognized based on his/her biological traits by comparing time constant components in the 5D images with stored values associated with the biological traits of respective persons.

### BACKGROUND OF THE INVENTION

1. Field of the Invention

The disclosure relates to the recognition of a human being based on biological and behavioristic traits.

2. Background Discussion

There are known methods and devices to identify and verify a human being using biometric traits, commonly referred to as recognition. These biometric traits can divided into two categories of traits: biological and behavioristic. Biological traits include innate biometric traits, which are generally stable in time and independent of human activities, such as finger or palm prints, iris, visible or infrared photo images of the face, hand contour, three-dimensional facial images, DNA structure, skull structure, etc. Behavioristic traits comprise biometric traits involving behavior acquired by a human being during his or her lifetime, which are long and stable enough to be identifiable with respect to a person, such as handwriting (both including and excluding motor specifics), voice, articulation, gestures, mimics, etc.

Non-contact biological recognition methods are known that utilize biological traits to perform recognition of a person. These non-contact recognition methods are utilized in access control systems, social and state programs involving large numbers of people (e.g., immigration and passport control, driver's licenses), visitor registration systems, etc. Examples of such non-contact recognition methods include human recognition methods based on iris imaging as well as two-dimensional and three-dimensional facial imaging. Iris imaging is considered to be an accurate recognition method, although its practical application is reduced by the level of cooperation required by a person to image his/her iris and also by the costs associated with such a method. Recognition by two-dimensional facial imaging is generally less costly, but at the same time it is a less accurate recognition method and most limited by the operating terms range. Three-dimensional image recognition methods have a high level of precision that have recently approached the same level of accuracy as iris recognition methods, require less cooperation by the recognized person than iris recognition methods, have a wide range of operating terms, and are generally priced at an intermediate level between two-dimensional image recognition methods and iris recognition methods.

One of the common drawbacks associated with all of the above-listed biological recognition methods is that they generally possess a low resistance to fraud, because the biometric traits that are used in such recognition methods can sometimes be easily imitated. It is difficult or impossible for such biological recognition methods to determine whether actual or imitated biological traits of a person are being verified by such methods.

Another common drawback associated with all of the above-listed biological recognition methods is that each of them is incompatible with a certain percent of the population. Yet another common drawback associated with all of the above-listed biological recognition methods is that each of them requires considerable cooperation from persons being recognized.

### SUMMARY

In accordance with one or more embodiments, a system and method are provided for the biometric recognition of a human being based on a combination of biological and behavioristic traits in order to achieve increased recognition performance and to protect against false identifications based on imitated traits.

In accordance with one or more embodiments, a plurality of time-sequenced 5D images are captured of at least a portion of a body of a person and used to recognize a person based on his/her behavioristic traits by comparing time variable components in the 5D images with stored values associated with the behavioristic traits of respective persons, while the person can be further recognized based on their biological traits by comparing time constant components in the 5D images with stored values associated with the biological traits of respective persons.

### DRAWINGS

The above-mentioned features and objects of the present disclosure will become more apparent with reference to the following description taken in conjunction with the accompanying drawings wherein like reference numerals denote like elements and in which:

FIG. 1 is a block diagram perspective view of a system for the biometric recognition of a human being based on a combination of biological and behavioristic traits in accordance with one or more embodiments of the present disclosure.

FIG. 2 is an operational flow diagram of a method for the biometric recognition of a human being based on a combination of biological and behavioristic traits in accordance with one or more embodiments of the present disclosure.

FIG. 3 illustrates time-sequenced 5D images of a person for use in determining the behavioristic traits of the person in accordance with one or more embodiments of the present disclosure.

### DETAILED DESCRIPTION

In general, the present disclosure includes a system and method for the biometric recognition of a human being based on a combination of biological and behavioristic traits in accordance with one or more embodiments of the present disclosure. Certain embodiments of the present disclosure will now be discussed with reference to the aforementioned figures, wherein like reference numerals refer to like components.

In one or more embodiments, a system and method for the biometric recognition of a human being are provided that use behavioristic traits in addition to biological traits to achieve increased recognition performance and to protect against false identifications based on imitated traits. Behavioristic traits comprise biometric traits involving behavior acquired by a human being during his or her lifetime that are capable of being associated with an individual.

In one or more embodiments, human recognition can be achieved using both behavioristic traits and biological traits of a person that are obtained from images of the person. In one or more embodiments, at least one 5D image of the person's body can be used to recognize the person by biological traits, while a plurality of time-sequenced 5D images of the person's body can be used to recognize the person by behavioristic traits. When referring to a 5D image in the present disclosure, such references shalt refer to a combination of components from a three-dimensional (3D) image and a two-dimensional (2D) image and/or any combination of 3D and 2D images. The combined 3D and 2D images can be captured from the same or different points of view, where the combined 3D and 2D images may further capture the same or different parts of the object's surface.

It is also understood that when referring to an image of the person's body, such references shall refer to images of any part of the surface of the person's body or any combination of any parts of the surface of the person's body, including, but not limited to, the person's body, hands, palms, legs, head and/or face. When recognizing a person by biological traits, a recognition procedure can be implemented that involves comparing measured biometric traits values extracted from an image with registered or stored values relating to a person or persons to be identified. In one or more embodiments, when utilizing 5D image recognition, the present system and method will i) analyze biological traits using information in the 5D images that relate to constant components and ii) analyze biometric traits using information in the 5D images that relate to variable components. In order to determine behavioristic traits of the person using 5D images, a plurality of 5D images of a person are taken consecutively in a time sequence when registering or enrolling the behavioristic traits. When performing recognition, the system captures a plurality of 5D images of a person, analyzes them to extract biometric and behavioristic traits, and compares the extracted traits against the traits registered earlier and associated with particular human beings.

In one or more embodiments, the time-sequenced 5D images of the person's body are used to determine variable components of the person's body (some of which could be considered as behavioral traits), which will further allow determining of constant components of the person's body (some of which could be considered as biological traits) with better quality than could be achieved with just one 5D image of the person's body. Such an analysis increases performance of the human recognition system not only just by fusion of analysis of biological and behavioral traits but also by acquisition of biological traits with better quality.

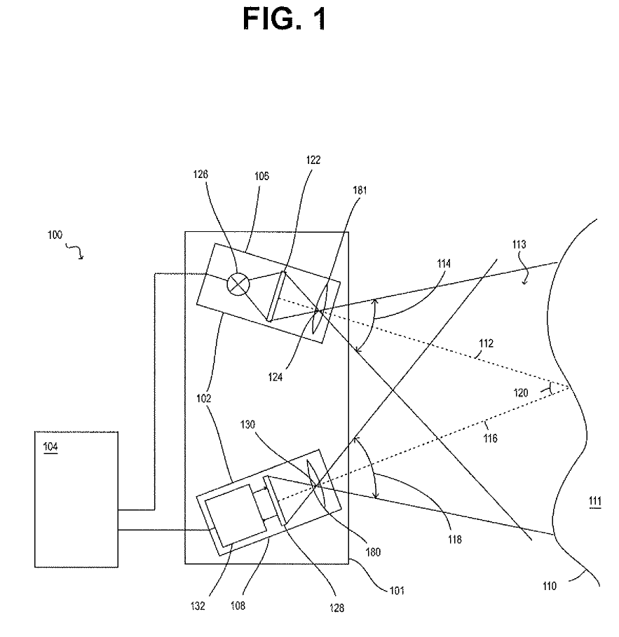

Referring now to FIG. 1, a block diagram illustration of a biometric recognition system 100 for the recognition of a human being based on a combination of biological and behavioristic traits is illustrated in accordance with one or more embodiments.

In one or more embodiments, the system 100 includes an object capturing device 102 and a computing device 104. The object capturing device includes at least one projection device 106 and at least one detection device 108. In at least one embodiment, the projection device 106 is a slide projector including a light source 126 and a light modulating device 122 for modulating the light emitted from the light source 126. The light modulating device 122 may be a slide-type device including a slide, a liquid crystal display (LCD)-type including a liquid crystal screen, or other device for creating a structured light 113. In at least one embodiment, the projection device 106 may include a lens 181 having a vertex 124 for projecting a slide image as structured light 113 about a projection area 114 onto a surface 110 of person 111. In accordance with this and other embodiments, the structured light 113 can also be generated using other methods, such as interferential, moir and diffractive light generation methods.

In at least one embodiment, the projection device 106 projects the structured light 113 in a wavelength selected from one of optical, visible and infrared wavelengths. In at least one embodiment, the projection device 106 is a continuous light source.

In at least one embodiment, the detection device 108 may include a photographic lens 180 having a vertex 130, a matrix radiation receiver 128 and a driver 132. The photographic lens 180 forms an image on the surface of the matrix radiation receiver 128. The driver 132 functions as an electronic signal management and processing unit which controls operation of the matrix radiation receiver 128 and may convert the image captured by the matrix radiation receiver 128 to another format (e.g., VGA, bmp, jpeg, etc.) as desired or required before the captured image is transferred to a computing device 104. The detection device 108 may include a field of view 118 that encompasses a portion of the surface 110 of the person 111. The projection device 106 may include a projector axis 112, and the detection device 108 may include a detector axis 116, such that a triangulation angle 120 is the angle between the projector axis 112 and the detector axis 116.

The computing device 104 receives output from the detection device 108 and analyzes the captured images received from an output of the detection device 108 to perform the desired calculations, such as but not limited to the 3D shape of the surface 110 of the person 111, calculations associated with recognition of a human being based on biological traits, calculations associated with recognition of a human being based on behavioristic traits, calculations associated with recognition of a human being based on both biological and behavioristic traits, 2D shape of the surface 110 of the person 111, the distance to the person 111 and the orientation of the surface 110 being captured. The computing device 104 can also control the projection device 106 and the detection device 108 and their various components included therein.

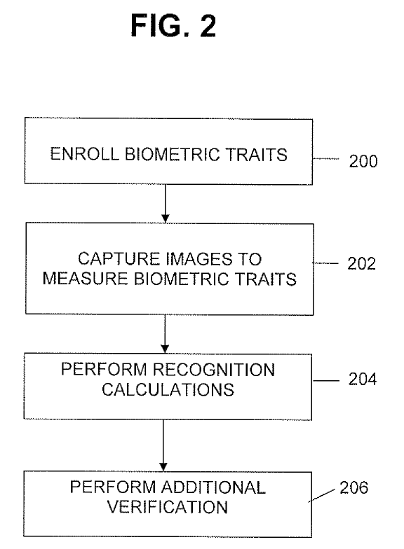

Referring now to FIG. 2, an operational flow diagram is illustrated of a process employed by the system 100 for the recognition of a human being based on biological and/or behavioristic traits in accordance with one or more embodiments. Initially, in step 200 the biometric traits of at least one human being are enrolled in the system 100 and associated with a particular human being's personality. Biometric traits may be enrolled by initially capturing images of at least one person, wherein at least one image is required for biological traits and a plurality of time-sequenced images are required for enrolling behavioristic traits. The captured images are analyzed to extract certain biometric (biological and/or behavioristic) traits associated with the images, and the generated biometric traits are stored or enrolled as a personality associated with the person. In one or more embodiments, the biometric traits may also be enrolled with the system 100 by retrieving previously obtained biometric traits about at least one person, where the previously obtained biometric traits may be stored in memory or another component of the system 100 or may input or otherwise obtained from another data source external to the system 100.

In step 202, the system 100 measures the biometric traits of a person situated in front of the object capturing system 102 by capturing and analyzing at least one image of the person. In one or more embodiments, a plurality of time-sequenced images are captured to measure the behavioristic traits of the person, where only one image may be required to measure the biological traits of the person. In step 204, the measured biometric traits extracted from the captured images are compared against the enrolled biometric traits (e.g., previously enrolled images of the person or data associated therewith) to determine whether the person is recognized by determining whether a match exists between the measured biometric traits and any of the enrolled biometric traits. From this comparison, the recognition system 100 can determine whether a personality recognition has resulted based on the biometric traits of the person. The system 100 system may perform recognition using only behavioristic traits or a combination of behavioristic and biological traits. The system 100 may further perform additional verification of the person in step 206 by analyzing secondary information, such as but not limited to other biometric traits of the person or identifying information received regarding the person (e.g., status of the person, entered PIN codes, responses to queries, information obtain from contact or non-contact cards, time of the day, etc.). The system 100 may include an input device for a person to input such identifying information.

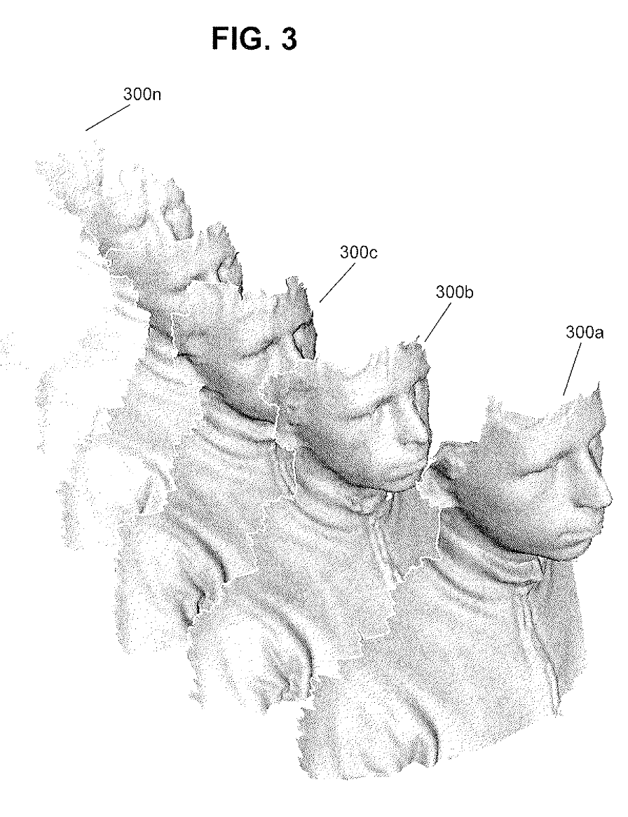

Referring now to FIG. 3, in one or more embodiments, recognition of the behavioristic traits of a person can be performed by the system 100 by capturing a plurality of 5D images of a person's body, where the images 300a, 300b, . . . , 300n shown in FIG. 3 illustrate time-sequence 3D images captured at n consecutive points in time. These images can be used to recognize the personality of a person by analyzing the behavioristic traits as set forth in the methods described herein. From the captured images, time constant components of the surface 110 captured (e.g., biological traits of the person) can be measured in addition to time variable components of the surface 110 captured (e.g., behavioristic traits of the person). Identification of a person can be obtained by comparing the constant surface components registered during identification and enrollment against the measured constant surface components in the at least one captured images. However, recognition is not complete until the time variable surface components in the images are compared against enrolled variable surface components for such person to verify the accuracy of the recognition of the person using behavioristic traits.

In this manner, the use of behavioristic biometric traits (e.g., time variable changes in the surface of the human body) that are extremely difficult to mimic or copy provide an increased accuracy when performing human recognition and also provide protection from the imitation of biometric data of the person being subject to recognition.

In one or more embodiments, behavioristic traits can be registered, as a rule, in a certain context. For example, handwriting can be linked to a word or a sentence, while voice and articulation can be linked to a phrase or code word. The registration of context-linked behavioristic traits simplifies the task of identifying a human being and provide improved reliability for a recognition system. In one or more embodiments, for a successful recognition, a human being shall provide not only the biometric trait to the system, but also the context (code word, phrase, etc), without which the recognition will not be successful. In such context-based recognition, the behavioristic trait that is enrolled, measured and compared for recognition purposes is associated with a particular context in order to further increase the accuracy of the recognition. For example, a person can be requested to speak a certain word or phrase during enrollment and identification, which will then serve to act as a context for the behavioristic trait. During recognition procedures, the person will be required to speak the same phrase so that the behavioristic trait can be analyzed with respect to the same context, in order to increase also adds to the decision-making on human personality. Certain portions of the person's body may move in a unique, identifiable manner to serve as the behavioristic trait in accordance with the context in question.

In one or more embodiments, recognition can be performed using behavioristic traits in a plurality of contexts. In such embodiments, enrollment might be carried out for each person several times in various contexts, and the number and content of the contexts may differ respectively for different people. During recognition procedures, the system 100 may require the same contexts in order to measure the respective behavioristic traits. Alternatively, the system 100 may be initially unaware of which particular context to be used, where the decision on which human behavioristic trait is to be analyzed is estimated according to the biological trait that is measured. Further, the content of the context can be used in particular to determine subsequent system reaction. For example, the system 100 can be used with ATM machines when the context selected by a person can tell the ATM machine whether the person is using its services voluntarily or under pressure. If voluntarily, the system 100 could recognize the person and authorize the transaction, while the system 100 may reject the person as not being recognized if it is determined that the person is under pressure, or otherwise may perform any other predetermined action (e.g., informing security services or police about the person under pressure and requesting assistance).

In one or more embodiments, the system 100 performs recognition using only the behavioristic traits of a person.

In one or more embodiments, the system 100 uses the behavioristic trait recognition procedures described herein as an additional measure of accuracy that is used in conjunction with other biometric trait recognition procedures. For example, biological trait recognition procedures can be used to supplement the behavioristic trait recognition procedures, such as analyzing two-dimensional images of a person's face or/and iris.

In one or more embodiments, the system 100 performs recognition by comparing the measured traits against the stored traits using a matching formula. The formula defines how and in what sequence the traits should be compared and how the final conclusion should be generated. In one example, the matching formula may assume that at least one measured trait should match to the at least one respective stored trait. In another example, the matching formula may assume that all the measured traits should match to the respective stored traits. In another example, the matching formula may assume that the measured traits should be compared the respective stored traits in a certain sequence, where each of the measured traits should match to the respective stored trait with a certain level of similarity. The mentioned matching formulas are only few examples of a suitable matching formulas and are not intended to suggest each and every possibility nor provide any limitation as to the scope of use or functionality of the invention.

In one or more embodiments, the computing system 104 may control operating of the image capturing system 102 and perform the necessary calculations for biometric trait recognition of a person. The computing system 104 may comprise a general-purpose computer system which is suitable for implementing the method for the biometric recognition of a human being based on a combination of biological and behavioristic traits in accordance with the present disclosure. The computing system 104 is only one example of a suitable computing environment and is not intended to suggest any limitation as to the scope of use or functionality of the invention. In various embodiments, the present system and method for the biometric recognition of a human being based on a combination of biological and behavioristic traits is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, programmable consumer electronics, networked PCs, minicomputers, mainframe computers, distributed computing environments that include any of the above systems or devices, and the like.

In various embodiments, algorithms utilized in the method for the biometric recognition of a human being based on a combination of biological and behavioristic traits may be described in the general context of computer-executable instructions, such as program modules, being executed by a computer. Generally, program modules include routines, programs, objects, components, data structures, etc. that perform particular tasks or implement particular abstract data types. These algorithms and methods may also be practiced in distributed computing environments where tasks are performed by remote processing devices that are linked through a communications network. In a distributed computing environment, program modules may be located in both local and remote computer storage media including memory storage devices. In one embodiment, the computing system implements multiframe surface measurement of the shape of material objects by executing one or more computer programs. The computer programs and data relied may be stored in a memory medium or storage medium such as a memory and/or ROM, or they may be provided to a CPU through a network connection or other I/O connection.

The system and method formed in accordance with the embodiments described herein provide non-contact methods of identifying, recognizing and verifying a human being by biological and behavioristic biometric traits. The system and method described herein provide autonomous high-precision and real-time verification of a person while requiring insignificant cooperativeness from a person. The system and method use a combination of biological and behavioristic traits for recognizing the personality of a human being, thereby providing increased recognition accuracy and reducing the likelihood that biometric traits can be mimicked or copied.

What is claimed is:

1. A human recognition method, comprising:
measuring at least one behavioristic trait of a person;
measuring at least one biological trait of the person;
comparing at least one of the measured behavioristic traits against at least one stored behavioristic trait, where each stored behavioristic trait is associated with a respective person;
comparing at least one of the measured biological traits against at least one stored biological trait, where each stored biological trait is associated with a respective person; and
when the measured behavioristic and biological traits respectively match the stored behavioristic and biological traits according to predefined matching characteristics, recognizing the measured person as a person associated with the matched stored behavioristic and biological traits.

2. The human recognition method of claim 1, wherein at least one of the behavioristic and biological traits is extracted from at least one 5D image of at least a portion of the person's body.

3. The human recognition method of claim 2, wherein the predefined matching characteristics are determined from a matching formula that assumes that at least one of the measured behavioristic and biological traits should match to at least one of the stored behavioristic and biological traits.

4. The human recognition method of claim 3, wherein the matching formula assumes that all of the measured behavioristic and biological traits should match to respective stored behavioristic and biological traits.

5. The human recognition method of claim 2, further comprising verifying a recognized person using additional identifying information received regarding the person.

6. The human recognition method of claim 2, wherein at least one of the behavioristic traits is extracted from captured time sequenced 5D images of at least a portion of the person's body by measuring time variable components between the captured images.

7. The human recognition method of claim 6, wherein at least one of the biological traits is extracted from captured time sequenced 5D images of at least a portion of the person's body by measuring time stable components between the captured images.

8. The human recognition method of claim 7, further comprising linking at least one of the behavioristic traits with at least one context.

9. The human recognition method of claim 8, wherein at least one of the biological traits is a human face, at least one of the behavioral traits is a human articulation mimic and at least one of the contexts is a code phrase.

10. The human recognition method of claim 8, further comprising executing one of plurality of possible predetermined actions chosen depending on particular context used by recognized person.

11. A human recognition system, comprising:
an image capturing device for capturing at least one image of at least a portion of a person's body;
at least one stored behavioristic trait associated with at least one respective person;
at least one stored biological trait associated with at least one respective person;
and
a computing device for
measuring at least one behavioristic trait of a person from the at least one captured image;
measuring at least one biological trait of the person from the at least one captured image;
comparing at least one of the measured behavioristic traits against at least one stored behavioristic trait, where each stored behavioristic trait is associated with a respective person;
comparing at least one of the measured biological traits against at least one stored biological trait, where each stored biological trait is associated with a respective person; and
when the measured behavioristic and biological traits respectively match the stored behavioristic and biological traits according to predefined matching characteristics, recognizing the measured person as a person associated with the matched stored behavioristic and biological traits.

12. The human recognition system of claim 11, wherein the image capturing device captures at least one 5D image of at least a portion of the person's body and the computing device extracts at least one of the behavioristic and biological traits from the at least one 5D image.

13. The human recognition system of claim 12, wherein the computing device determines the predefined matching characteristics from a matching formula that assumes that at least one of the measured behavioristic and biological traits should match to at least one of the stored behavioristic and biological traits.

14. The human recognition system of claim 13, wherein the matching formula assumes that all of the measured behavioristic and biological traits should match to respective stored behavioristic and biological traits.

15. The human recognition system of claim 12, further comprising an input device for receiving additional identifying information regarding the person being measured, wherein the computer device further verifies a recognized person using additional identifying information received regarding the person.

16. The human recognition system of claim 12, wherein the image capturing device captures a plurality of time sequenced 5D images of at least a portion of the person's body, wherein the computing device extracts at least one of the behavioristic traits from captured time sequenced 5D images by measuring time variable components between the captured images.

17. The human recognition system of claim 16, wherein the computing system extracts at least one of the biological traits from captured time sequenced 5D images of at least a portion of the person's body by measuring time stable components between the captured images.

18. The human recognition system of claim 17, wherein at least one of the behavioristic traits is linked with at least one context.

19. The human recognition system of claim 18, wherein at least one of the biological traits is a human face, at least one of the behavioral traits is a human articulation mimic and at least one of the contexts is a code phrase.

20. The human recognition system of claim 18, wherein the computing system further executes one of plurality of possible predetermined actions chosen depending on particular context used by recognized person.
